(19) United States
(12) Patent Application Publication
(10) Pub. No.: US 2004/0091780 A1
(43) Pub. Date: May 13, 2004

(54) Nonaqueous electrolyte secondary battery

(76) Inventors: Akira Kinoshita, Kobe-city (JP); Hiroyuki Fujimoto, Kobe-city (JP); Yasufumi Takahashi, Kobe-city (JP); Toyoki Fujihara, Kobe-city (JP); Shingo Tode, Kobe-city (JP); Ikuro Nakane, Kobe-city (JP); Shin Fujitani, Kobe-city (JP)

Correspondence Address: KUBOVCIK & KUBOVCIK, SUITE 710, 900 17TH STREET NW, WASHINGTON, DC, 20006

(21) Appl. No.: 10/701,572

(22) Filed: Nov. 6, 2003

(30) Foreign Application Priority Data
Nov. 7, 2002 (JP) 2002-324173

(51) Int. Cl. H01M 4/50; H01M 4/52; H01M 2/02; H01M 10/52

(52) U.S. Cl. 429/231.1; 429/223; 429/224; 429/176; 429/231.3; 429/59

(57) ABSTRACT

A nonaqueous electrolyte secondary battery including an airtight outer container, the shape of which can be changed by an increase of battery internal pressure; a material capable of occluding and releasing lithium as a negative electrode material; and a lithium-transition metal composite oxide having a layer structure in which nickel and manganese are contained as transition metals and containing fluorine as a positive electrode material.

### FIELD OF THE INVENTION

The present invention relates to a nonaqueous electrolyte secondary battery. Specifically, the present invention relates to a nonaqueous electrolyte secondary battery comprising a lithium-transition metal composite oxide containing nickel and manganese as a positive electrode material.

### BACKGROUND OF THE INVENTION

A nonaqueous electrolyte secondary battery comprising a carbon material, lithium metal or a material capable of forming an alloy with lithium as a negative electrode active material and a lithium-transition metal composite oxide represented by LiMO₂ (wherein M is a transition metal) as a positive electrode active material has recently received attention as a secondary battery having a high energy density.

As a typical lithium-transition metal composite oxide, lithium cobalt oxide (LiCoO₂) can be illustrated. This material has been used commercially as the positive electrode active material for a nonaqueous electrolyte secondary battery.

A lithium-transition metal composite oxide including nickel or manganese as a transition metal has been considered for use as a positive electrode active material. A material including all three transition metals, i.e., cobalt, nickel and manganese, has also been researched and developed as described in Japanese Patent Publication Nos. 2,561,556 and 3,244,314 and the Journal of Power Sources 90 (2000), pp. 176-181.

It has been reported that lithium-transition metal composite oxide including nickel and manganese in an equal ratio which is represented by the formula LiMnₓNiₓCo₍₁₋₂ₓ₎O₂, among lithium-transition metal composite oxides, has extremely high heat stability at a charge condition (high oxidation condition) (Electrochemical and Solid-State Letters, 4 (12) A200-A203 (2001)).

It has also been reported that lithium-transition metal composite oxide including nickel and manganese in a substantially equal ratio has a voltage of about 4 V, equal to that of LiCoO₂, and exhibits a large capacity and excellent charge-discharge efficiency (Japanese Patent Laid-open Publication No. 2002-42813). Therefore, a battery comprising a lithium-transition metal composite oxide including cobalt, nickel and manganese and having a layer structure, for example, LiₐMn_{b}Ni_{b}Co_{(1-2b)}O₂ (wherein 0≦a≦1.2 and 0<b≦0.5), as a positive electrode material can be expected to provide a great improvement in battery stability because of excellent heat stability at a charge condition.

The use of a mixture of a lithium-transition metal composite oxide and lithium cobalt oxide for a positive electrode material for a coin-shape cell has also been disclosed (Japanese Patent Laid-open Publication No. 2002-100357).

The characteristics of a lithium secondary battery comprising a lithium-transition metal composite oxide including cobalt, nickel and manganese as a positive electrode active material have been researched. It was found that a battery, especially a battery used for a cellular phone, expands when the battery is stored at a high temperature, for example, at more than 80° C., which is expected as a condition of use of a cellular phone in a car, and at a charge condition, because of the generation of gas which is believed to be caused by a reaction of a positive electrode material and an electrolyte. A battery of which an outer container is prepared from a thin aluminum alloy or aluminum laminate tends to expand significantly and characteristics of the battery, for example, reduction of battery capacity and the like, are deteriorated.

### OBJECT OF THE INVENTION

An object of the present invention is to reduce the generation of gas during storage of a nonaqueous electrolyte secondary battery comprising a lithium-transition metal composite oxide as a positive electrode material at a high temperature and under a charge condition, to prevent expansion of the battery caused by the generated gas, and to provide a nonaqueous electrolyte secondary battery having improved storage characteristics.

### SUMMARY OF THE INVENTION

The present invention is characterized in that in a nonaqueous electrolyte secondary battery prepared by using an airtight outer container, the shape of which is changed by an increase of internal pressure, and a material capable of occluding and releasing lithium as a negative electrode material, a lithium-transition metal composite oxide having a layer structure in which nickel and manganese are the transition metals and containing fluorine is used as a positive electrode material.

### BRIEF DESCRIPTION OF THE DRAWINGS

FIG. 1 is a plan view of a lithium secondary battery as prepared in the Examples.

FIG. 2 is a photograph of the front of the negative electrode of Example 3 showing the condition of the electrode when the battery is charged after the storage test.

FIG. 3 is a photograph of the back of the negative electrode of Example 3 showing the condition of the electrode when the battery is charged after the storage test.

FIG. 4 is a photograph of the front of the negative electrode of Comparative Example 1 showing the condition of the electrode when the battery is charged after the storage test.

FIG. 5 is a photograph of the back of the negative electrode of Comparative Example 1 showing the condition of the electrode when the battery is charged after the storage test.

FIG. 6 is a photograph of the battery of Comparative Example 1 showing the condition before the storage test.

FIG. 7 is a photograph of the battery of Comparative Example 1 showing the condition after the storage test.

FIG. 8 is a cross section of a three-electrode beaker cell prepared in Reference Experiment 2.

FIG. 9 is an XRD pattern of the positive electrode of Comparative Example 1 before the storage test

FIG. 10 is an XRD pattern of the positive electrode of Comparative Example 1 after the storage test.

[Explanation of Elements]

1: outer container

2: seal portions

3: positive electrode current collector tab

4: negative electrode current collector tab

11: working electrode

12: counter electrode

13: reference electrode

14: electrolyte

### DETAILED EXPLANATION OF THE INVENTION

According to the present invention, addition of fluorine to the lithium-transition metal composite oxide can reduce the generation of gas during storage at a high temperature under a charge condition. Therefore, expansion of the battery can be prevented and storage characteristics of the battery can be improved.

Internal pressure is increased by gas generated during storage of a battery including a lithium-transition metal composite oxide as an electrode material. The gas is believed to be generated by a reaction between the lithium-transition metal composite oxide and an electrolyte as described below in a reference experiment.

The gas generated during storage of the battery tends to remain between the electrodes when the positive and negative electrodes have rectangular electrode faces and the battery is also rectangular. Therefore, the present invention is specifically effective when the battery and the electrodes are rectangular.

As positive and negative electrodes having rectangular faces, a positive electrode and a negative electrode facing each other through a separator are wound so as to be flat or are folded to make the face rectangular. A rectangular positive electrode and a rectangular negative electrode layered one by one are also illustrated.

As the outer container capable of deformation by an increase in the internal pressure, aluminum alloy and an aluminum laminate film and the like having a thickness, at least partially, of not greater than 0.5 mm can be illustrated. The aluminum laminate film for the present invention is a laminated film comprising a plastic film laminated on the both sides of an aluminum foil. As the plastic film, polypropylene, polyethylene, and the like, are generally used. An outer container, at least a part of which comprises an iron alloy having a thickness of 0.3 mm or less, is also included. When the internal pressure of the battery increases, the part formed of such a material expands to change the shape of the container.

As the lithium-transition metal composite oxide, one represented by the formula, LiₐMnₓNi_{y}Co_{z}O₂ (wherein a, x, y and z satisfy 0≦a≦1.2, x+y+z=1, x>0, y>0, and z≧0), is preferable. It is preferable that an amount of nickel and an amount of manganese are substantially the same. That is, it is preferable that x and y in the above formula are the same. Nickel has a characteristic that it has a large capacity but does not have good heat stability under a charging condition. Manganese has a characteristic that it has a small capacity but has good heat stability under a charging condition. Therefore, the amount of nickel and that of manganese are preferably substantially same so as to provide a good balance of such characteristics.

More preferable ranges of x, y and z are 0.25≦x≦0.5, 0.25≦y≦0.5 and 0≦z≦0.5, respectively.

BET specific surface area of the lithium-transition metal composite oxide is preferably 3 m²/g or less. This is because the transition metal at the surface of the positive electrode active material having a high oxidation level catalyzes gas generation in the charged battery and a smaller specific surface area of the positive electrode active material is believed preferable.

A mean diameter of the lithium-transition metal composite oxide (a mean diameter of secondary particles) is preferably 20 μm or less. If the mean diameter is too large, a distance of movement of lithium in the particles becomes long and discharge characteristics deteriorate.

An amount of fluorine included in the lithium-transition metal composite oxide is preferably in a range of 100 ppm and 20000 ppm. If the amount of fluorine is too little, generation of gas cannot be sufficiently inhibited. If the amount of fluorine is too great, discharge characteristics of the positive electrode are badly affected.

There is no limitation with respect to a method of incorporating fluorine in the lithium-transition metal composite oxide. A fluorocompound can be added to the ingredients when the lithium-transition metal composite oxide is prepared. As the fluorocompound, for example, LiF, and the like can be illustrated.

An amount of fluorine included in the lithium-transition metal composite oxide can be measured by an ion meter and the like.

Another aspect of the present invention is a method for reducing generation of gas during storage of a nonaqueous electrolyte secondary battery including a lithium-transition metal composite oxide as a positive electrode material, the method being characterized by the addition of fluorine to the lithium-transition metal composite oxide.

The mechanism by which a significant amount of gas is generated during storage of a battery, in which a lithium-transition metal composite oxide is included as a positive electrode material, at a high temperature under a charge condition, is not clear at this point. Therefore, the reasons why the addition of fluorine can reduce the generation of gas are not clear. However, it is presumed that when the battery is charged to oxidize the positive electrode active material, the transition metal (nickel or manganese), the oxidation level of which becomes high, acts as a catalyst at the surface of the active material to generate gas and when fluorine is included the oxidation condition of the transition metal element is changed to reduce the generation of gas.

There is no limitation with respect to the negative electrode material if the material is capable of occluding and releasing lithium and is conventionally used as a negative electrode material for a nonaqueous electrolyte secondary battery. For example, a graphite material, lithium metal, a material capable of forming an alloy with lithium, and the like can be used. As the material capable of forming an alloy with lithium, silicon, tin, germanium, aluminum, and the like, can be illustrated.

There is also no limitation with respect to the electrolyte to be used for the nonaqueous electrolyte secondary battery of the present invention if the electrolyte has been used as an electrolyte in a nonaqueous electrolyte secondary battery such as a lithium secondary battery. There is also no limitation with respect to the solvent to be used for the nonaqueous electrolyte. A mixed solvent of cyclic carbonates, for example, ethylene carbonate, propylene carbonate, butylene carbonate, vinylene carbonate, and the like, and chain carbonates, for example, dimethyl carbonate, methylethyl carbonate, diethyl carbonate, and the like, can be used. A mixture of a cyclic carbonate described above and an ether, for example, 1,2-dimethoxyethane, 1,2-diethoxyethane, and the like, can also be used.

There is no limitation with respect to a solute used in the electrolyte. LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and the like, can be used alone or in a combination thereof.

### Description of Preferred Embodiments

Embodiments of the present invention are explained in detail below. It is of course understood that the present invention is not limited to these embodiments and can be modified within the spirit and scope of the appended claims.

(Experiment 1)

### EXAMPLE 1

[Preparation of Positive Electrode Active Material]

LiOH, LiF and a coprecipitate hydroxide represented by Mn_{0.33}Ni_{0.33}CO_{0.34}(OH)₂ were mixed in an Ishikawa style mortar to provide a molar ratio of lithium to transition metals of 1:1 and to include fluorine in the lithium-transition metal composite oxide in an amount of 500 ppm after heat treatment. The mixture was treated at 1000° C. in an air atmosphere for 20 hours. After the heat treatment, it was ground to obtain a lithium-transition metal composite oxide represented by LiMn_{0.33}Ni_{0.33}Co_{0.34}O₂ including fluorine and having a mean particle diameter of about 5 μm. The BET specific surface area of the obtained lithium-transition metal composite oxide was 0.94 m²/g.

[Determination of Quantity of Fluorine]

10 mg of the lithium-transition metal composite oxide was measured and was mixed with 100 ml of a 20 weight % hydrochloric acid solution and the mixture was heated at about 80° C. for three hours to dissolve the lithium-transition metal composite oxide. Then, the amount of fluorine in the obtained solution was measured by an ion meter. The amount was 420 ppm.

[Preparation of Positive Electrode]

A positive electrode active material prepared as described above, carbon as a conductive agent and polyvinylidene fluoride (PVDF) were mixed in a ratio by weight of 90:5:5, and the mixture was added to N-methyl-2-pyrrolidone as a dispersion medium and was mixed to prepare a positive electrode slurry. The slurry was coated on an aluminum foil as a current collector, was rolled by a pressure roller after drying and a positive electrode was prepared by adding a current collector tab.

[Preparation of Negative Electrode]

Artificial graphite as a negative electrode active material and styrene-butadiene rubber (SBR) as a binding agent were added into a carboxymethylxellulose solution as a thickening agent to a ratio by weight of 95:3:2 (active material:binding agent:thickening agent), and were mixed to prepare a negative electrode slurry. The slurry was coated on a copper foil as a current collector and, after drying, the coated foil was rolled by a pressure roller and a negative electrode was prepared by attaching a current collector tab.

[Preparation of Electrolyte]

1 mol/l LiPF₆ was dissolved in a mixture (3:7) of ethylene carbonate (EC) and ethylmethyl carbonate (EMC) to prepare an electrolyte.

[Assembly of Battery]

The positive electrode, a separator and the negative electrode were laminated and the resultant laminate was rolled and flattened to prepare an electrode unit. The electrode unit was inserted into a bag, to be used as an outer container, made of an aluminum laminate having a thickness of 0.11 mm in a glove-box under an argon atmosphere, the electrolyte was poured into the container then the container was sealed.

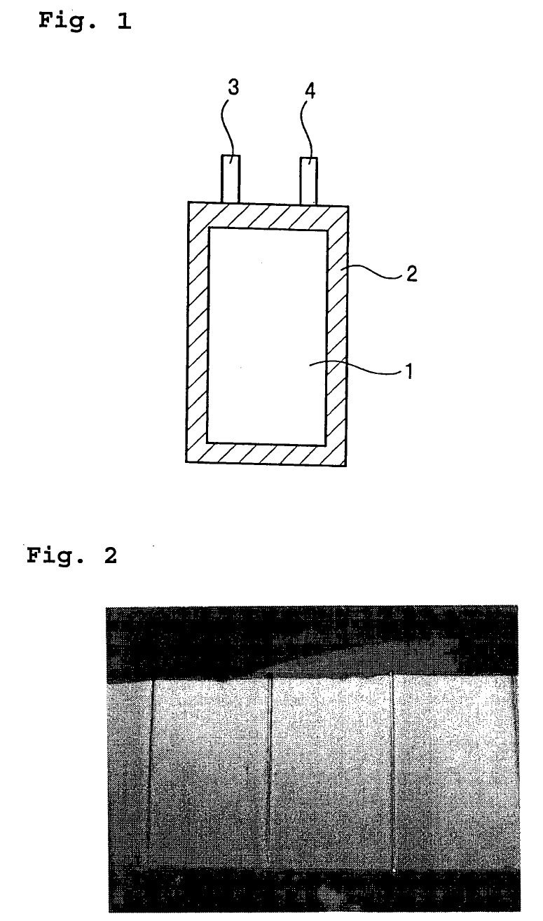

FIG. 1 is a plan view of the lithium secondary battery A1 prepared above. Edges of the aluminum laminate outer container 1 was treated by heat to form seal portion 2. The positive electrode current collector tab 3 and the negative electrode current collector tab 4 were pulled outside of the outer container 1. The battery was intended to have a thickness of 3.6 mm, a width of 3.5 cm and a length of 6.2 cm. The initial thickness of the prepared battery was 3.64 mm.

### EXAMPLE 2

A lithium secondary battery A2 was prepared in the same manner as the battery in Example 1 except that LiOH, LiF and a coprecipitate hydroxide represented by Mn_{0.33}Ni_{0.33}Co_{0.34}(OH)₂ were mixed to provide a molar ratio of lithium and transition metals of 1:1 and to include an amount of fluorine in the lithium-transition metal composite oxide after heat treatment of about 1300 ppm. The amount of fluorine in the obtained LiMn_{0.33}Ni_{0.33}Co_{0.34}O₂ was measured as the same manner as above and was 1200 ppm. The BET specific surface area was 0.72 m²/g. The thickness of the battery A2 was initially 3.69 mm.

### EXAMPLE 3

A lithium secondary battery A3 was prepared in the same manner as the battery in Example 1 except that LiOH, LiF and a coprecipitate hydroxide represented by Mn_{0.33}Ni_{0.33}Co_{0.34}(OH)₂ were mixed to provide a molar ratio of lithium and transition metals of 1:1 and to include an amount of fluorine in the lithium-transition metal composite oxide after heat treatment of about 8000 ppm. The amount of fluorine in the obtained LiMn_{0.33}Ni_{0.33}Co_{0.34}O₂ was measured in the same manner as above and was 7900 ppm. A BET specific surface area was 0.33 m²/g. The thickness of the battery A3 was initially 3.69 mm.

### COMPARATIVE EXAMPLE 1

A lithium secondary battery X1 was prepared in the same manner as the battery in Example 1 except that LiOH and a coprecipitate hydroxide represented by Mn_{0.33}Ni_{0.33}Co_{0.34}(OH)₂ were mixed to provide a molar ratio of lithium and transition metals of 1:1 (i.e., fluorine was not included). The thickness of the battery X1 was initially 3.80 mm.

[Evaluation of Storage Characteristics at High Temperature]

The lithium secondary batteries A1˜A3 and X1 were charged to a voltage of 4.2 V at a constant current of 650 mA, were continued to be charged to a current of 32 mA at a constant voltage of 4.2 V, then were discharged to a voltage of 2.75 at a constant current of 650 mA to obtain discharge capacities (mAh) before storage of the batteries.

The batteries were charged to a voltage of 4.2 V at a constant current of 650 mA at room temperature, were continued to be charged to a current of 32 mA at a constant voltage of 4.2 V, and then were stored in a constant temperature chamber at 85° C. for three hours. After storage the batteries were cooled at room temperature for one hour, and the thickness of each battery was measured. The obtained thickness was compared to the initial thickness to obtain the increase in thickness (mm) and an increase ratio (%) was calculated to evaluate expansion of the batteries and an expansion rate of the batteries. The results are shown in Table 1. The expansion rate (%) of the batteries is (increased in thickness)/(initial thickness)×100.

TABLE 1

| | | Content of | Expansion | |
|---|---|---|---|---|
| | | F in Positive | after Storage at | |
| | | Electrode Active | High Temperature | Expansion |
| | Battery | Material (ppm) | (mm) | Rate (%) |
| Example 1 | A1 | 420 | 0.41 | 11 |
| Example 2 | A2 | 1200 | 0.61 | 17 |
| Example 3 | A3 | 7900 | 0.52 | 14 |
| Comparative | X1 | 0 | 2.85 | 75 |
| Example 1 | | | | |

As is clear from the results shown in Table 1, batteries A1˜A3 including fluorine have a significantly smaller expansion and expansion rate as compared to battery X1 prepared without fluorine.

The batteries were discharged to a voltage of 2.75 at a constant current at room temperature to measure the remaining capacity (mAh). The remaining capacity was divided by the discharge capacity before storage to obtain a remaining rate.

After the remaining rates were measured, the batteries were charged to a voltage of 4.2 V at a constant current of 650 mA, were continued to be charged to a current of 32 mA at a constant voltage of 4.2 V, and then were discharged to a voltage of 2.75 V at a constant current of 650 mA to measure a return capacity. A return rate is defined as the return capacity divided by the discharge capacity before storage.

The discharge capacity before storage, remaining capacity, remaining rate, return capacity and return rate of each battery are shown in Table 2.

TABLE 2

| | | Content | | | |
|---|---|---|---|---|---|
| | | of F in | | | |
| | | Positive | | Remaining | Return |
| | | Electrode | | Capacity | Capacity |
| | | Active | Discharge | (mAh) | (mAh) |
| | | Material | Capacity | (Remaining | (Reuturn |
| | Battery | (ppm) | (mAh) | Rate) | Rate) |
| Example 1 | A1 | 420 | 696.7 | 596.8 | 616.4 |
| | | | | (85.7%) | (88.5%) |
| Example 2 | A2 | 1200 | 718.6 | 640.9 | 654.8 |
| | | | | (89.2%) | (91.1%) |
| Example 3 | A3 | 7900 | 620.1 | 536.4 | 553.4 |
| | | | | (86.5%) | (89.2%) |
| Comparative | X1 | 0 | 673.0 | 483.8 | 506.3 |
| Example 1 | | | | (71.9%) | (75.2%) |

As is clear from the results shown in Table 2, batteries A1˜A3 have significantly improved remaining capacity, remaining rate, return capacity and return rate as compared to battery X1 prepared without fluorine. When fluorine is included in the lithium-transition metal composite oxide, storage characteristics of the battery at a high temperature are improved.

[Observation of Condition of Negative Electrode]

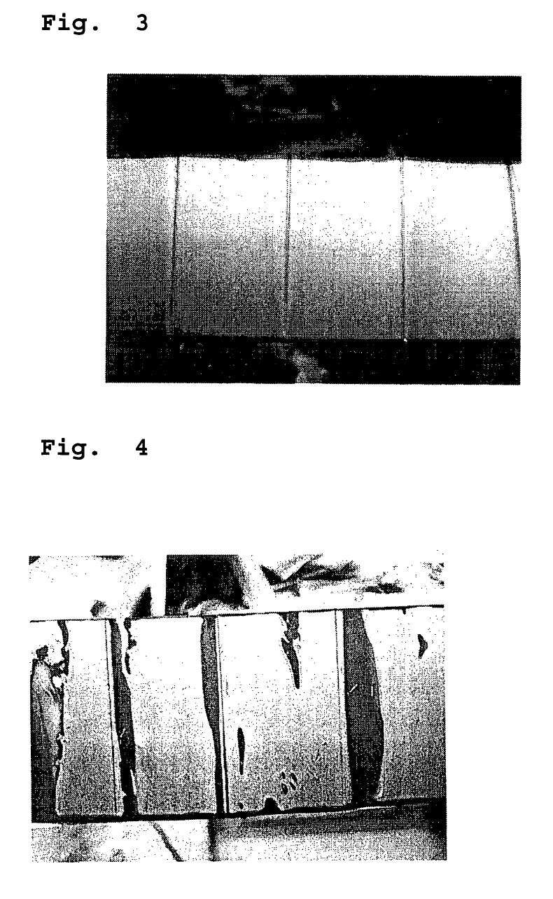

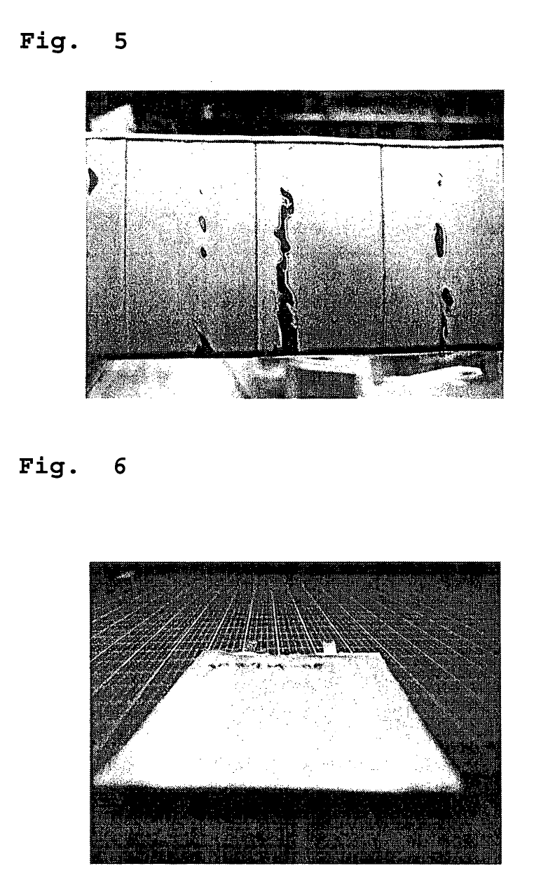

The condition of the negative electrodes after the storage test of battery A3 of Example 3 and battery X1 of Comparative Example 1 were observed. That is, after the storage test, the batteries were charged to a voltage of 4.2 V at a constant current of 650 mA, were continued to be charged to a current of 32 mA at a constant voltage of 4.2 V, and then were taken apart to obtain the negative electrodes for observation. FIGS. 2 and 3 show the negative electrode of Example 3, and are the front and back, respectively. FIGS. 4 and 5 show the negative electrode of Comparative Example 1, and are front and back, respectively.

As is clear from a comparison of FIGS. 2 to 5, in battery X1 which expanded badly after the storage test non-reacted portions (black portions in the drawings) remained in portions changed color to gold (lighter portions in the drawings). It is believed that gas generated during storage remained as bubbles between the electrodes, and portions contacted by the bubbles were inhibited from reacting and non-reacted portions remained.

In the battery A3 of Example 3 remaining non-reacted portions on the charged negative electrode were not found. Therefore, the charge reaction occurred evenly in the electrode. When fluorine is included in the lithium-transition metal composite oxide according to the present invention, generation of gas can be inhibited during storage and a charge reaction can occur evenly in an electrode and deterioration of characteristics of the battery after storage at a high temperature can be prevented.

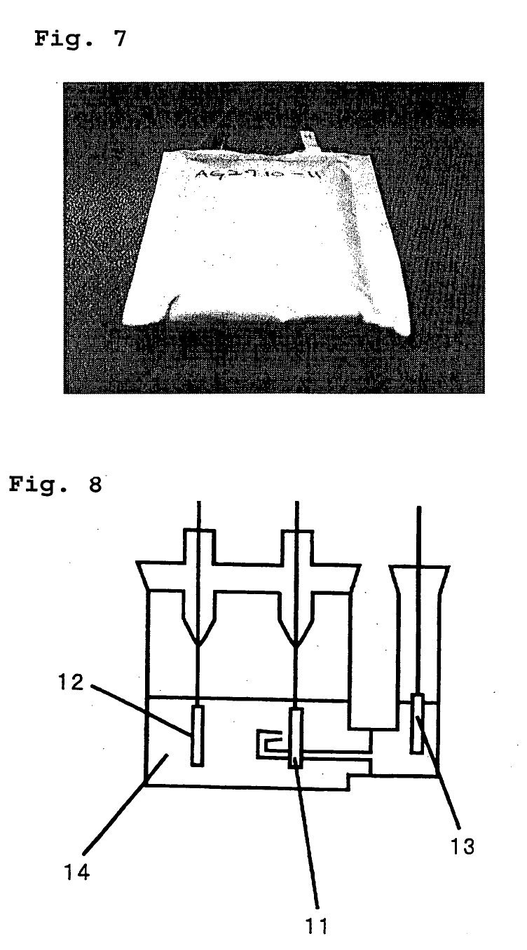

FIG. 6 is a photograph of battery X1 of Comparative Example 1 before the storage test, FIG. 7 is that after the storage test. As is clear from a comparison of FIGS. 6 and 7, the outer container of the battery was expanded.

(Reference Experiment 1)

A lithium secondary battery was prepared using an aluminum can as an outer container which was made of an aluminum alloy sheet having a thickness of 0.5 mm (Al-Mn-Mg alloy, JIS A3005, tolerance 14.8 kgf/mm²) to determine whether the battery was expanded after storage test.

[Preparation of Reference Battery]

Battery Y1 was prepared in the same manner as the battery of Example 1 except that LiMn_{0.33}Ni_{0.33}Co_{0.34}O₂ which dose not contain fluorine was used as a positive electrode active material, the outer container was the above-described aluminum alloy can, and the size of battery was intended to be a thickness of 6.5 mm, a width of 3.4 cm and a length of 5.0 cm. LiMn_{0.33}Ni_{0.33}Co_{0.34}O₂ without fluorine was prepared in the same manner as the preparation of LiMn_{0.33}Ni_{0.33}Co_{0.34}O₂ in Example 1 except that LiF was not used as an ingredient. An initial thickness of the prepared battery was 6.04 mm.

[Evaluation of Expansion of Battery after Storage at High Temperature]

Battery Y1 was charged to a voltage of 4.2 V at a constant current of 950 mA at a room temperature, was continued to be charged to a current of 20 mA at a constant voltage of 4.2 V, and then was stored in a constant temperature bath (thermostatic chamber) at 85° C. for three hours. After storage the battery was cooled at a room temperature for one hour, and a thickness of the battery was measured. Expansion of the battery after storage was evaluated in the same manner as in Example 1. The results are shown in Table 3.

TABLE 3

| | | Content of | | |
|---|---|---|---|---|
| | | F in Positive | Expansion after | |
| | | Electrode Active | Storage at High | Expansion |
| | Battery | Material (ppm) | Temperature (mm) | Rate (%) |
| Reference | Y1 | 0 | 1.42 | 24 |
| Battery | | | | |

As is clear from the results shown in Table 3, battery Y1 which did not include fluorine expanded badly (the expansion after storage at the high temperature was 1.42 mm). From this fact, it is understood that even if an aluminum alloy can having a thickness of 0.5 mm was used as the outer container, the container changed its shape by increased internal pressure. Therefore, it is expected that if fluorine is included in the lithium-transition metal composite oxide, generation of gas during storage at a high temperature can be reduced and it is possible to efficiently prevent expansion of a battery.

(Reference Experiment 2)

Battery X1 was taken apart to research the causes of deterioration of the battery after the storage test using the following examinations.

[Evaluation of Characteristics of Electrode]

A three-electrode beaker cell shown in FIG. 8 was prepared using the positive electrode obtained by taking apart battery X1 as a working electrode, lithium metal as a counter electrode and a reference electrode, and a mixture (ratio by volume of 3:7) of ethylene carbonate (EC) and ethylmethyl carbonate (EMC) containing 1 mol/l LiPF₆ as an electrolyte. As shown in FIG. 8, the working electrode 11, the counter electrode 12 and the reference electrode 13 were immersed in the electrolyte 14.

The cell prepared above was charged at a current density of 0.75 mA/cm² to 4.3 V (vs. Li/Li⁺), then was discharged at a current density of 0.75 mA/cm² to 2.75 V (vs. Li/Li⁺) to obtain a capacity (mAh/g) per weight of the positive electrode active material. Then the cell was charged at a current density of 0.75 mA/cm² to 4.3 V (vs. Li/Li⁺), then was discharged at a current density of 3.0 mA/cm² to 2.75 V (vs. Li/Li⁺) to obtain a capacity (mAh/g) per weight of the positive electrode active material. An average electrode potential during discharge at a current density of 0.75 mA/cm² was calculated by the following expression. The positive electrode before the storage test was also evaluated in the same manner as described above.

[Average electrode potential (V vs. Li/Li⁺)]=[Weight energy density at discharging (mWh/g)]÷[Capacity per weight (mAh/g)]

The results of the charge-discharge test at discharge current density of 0.75 mA/cm² are shown in Table 4, and the results of the charge-discharge test at discharge current density of 3.0 mA/cm² are shown in Table 5.

TABLE 4

| | Discharge | Energy | Average |
|---|---|---|---|
| Positive Electrode of | Capacity | Density | Electrode Potential |
| Comparative Example 1 | (mAh/g) | (mWh/g) | (V vs. Li/Li⁺) |
| Before Storage | 158.3 | 602.8 | 3.807 |
| After Storage | 155.6 | 589.3 | 3.787 |

TABLE 5

| | Discharge | Ratio of Discharge Capacity |
|---|---|---|
| Positive Electrode of | Capacity | at 3.0 mA/cm² to Discharge |
| Comparative Example 1 | (mAh/g) | Capacity at 0.75 mA/cm² (%) |
| Before Storage | 145.8 | 92.1 |
| After Storage | 143.5 | 92.2 |

As is clear from the results shown in Tables 4 and 5, there are no differences between the characteristics of the positive electrode before and after storage. Therefore, it is believed that no deterioration of the positive electrode active material or the positive electrode occurred by storage at the high temperature.

(Measurement of XRD Patterns Before and After Storage)

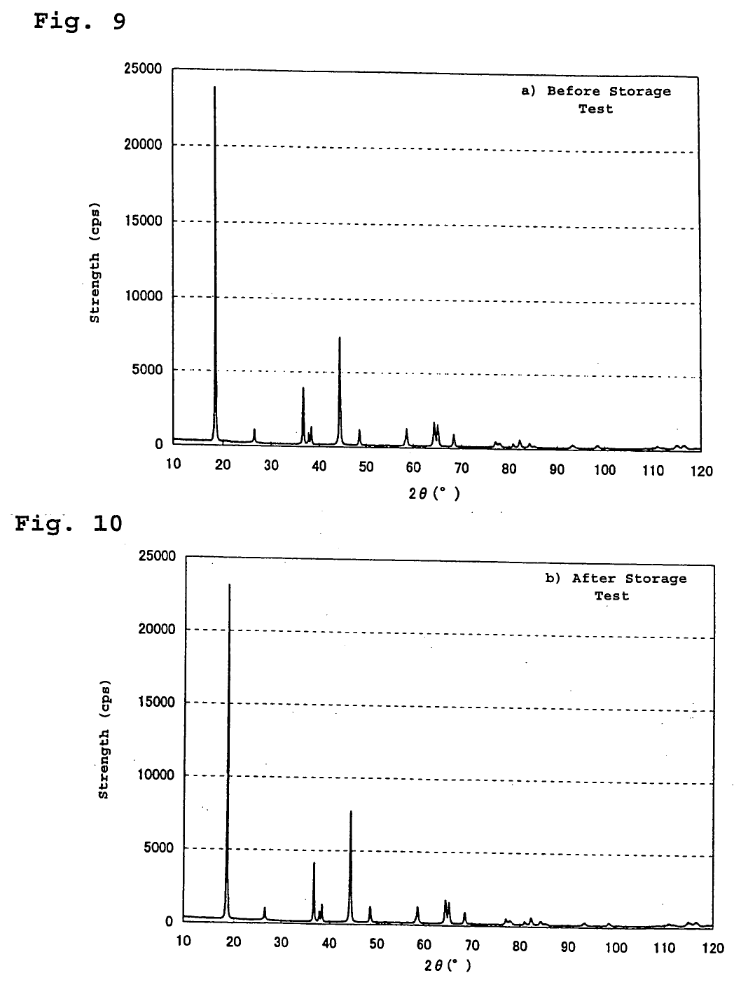

The positive electrode (at discharging condition) recovered after storage and before the storage test were submitted for X-ray diffraction analysis using Cu-K_{α} ray as a radiation source. The results are shown in FIGS. 9 and 10. FIG. 9 is an XRD pattern before the storage test and FIG. 10 is an XRD pattern after the storage test. As is clear from a comparison of FIGS. 9 and 10, there are no significant differences between the XRD patterns. Therefore, it is concluded that there are no structural changes of the positive electrode active material between before and after the storage test.

Deterioration of the batteries is not caused by structural changes of the positive electrode active material or deterioration of the electrode, but is because of uneven charge and discharge reactions caused by gas generated during storage and remaining between the electrodes. Therefore, the present invention can inhibit generation of gas during storage to prevent deterioration of characteristics of a battery.

### Advantages of the Invention

The present invention can decrease generation of gas during storage at a high temperature under a charging condition and can inhibit expansion of a battery to prevent deterioration of the characteristics of the battery caused by high temperature storage.

What is claimed is:

1. A nonaqueous electrolyte secondary battery comprising an airtight outer container capable of expanding by an increase of internal pressure; a material capable of occluding and releasing lithium as a negative electrode material; and a lithium-transition metal composite oxide having a layer structure in which nickel and manganese are contained as transition metals, and which contains fluorine, as a positive electrode material.

2. The nonaqueous electrolyte secondary battery according to claim 1, wherein at least part of the outer container is an aluminum alloy or aluminum laminate film having a thickness of 0.5 mm or less.

3. A rectangular nonaqueous electrolyte secondary battery comprising a positive electrode and a negative electrode, each electrode having a rectangular electrode face, wherein a material capable of occluding and releasing lithium is used as a negative electrode material, and a lithium-transition metal composite oxide having a layer structure in which Ni and Mn are contained as transition metals and to which fluorine has been added is used as a positive electrode material.

4. The nonaqueous electrolyte secondary battery according to claim 3, wherein the positive electrode and the negative electrode are in the form of a laminate that is wound and flattened.

5. A nonaqueous electrolyte secondary battery comprising a lithium-transition metal composite oxide having a layer structure in which nickel and manganese are contained as transition metals as a positive electrode material, and an outer container expandable by a gas generated during storage of the battery, wherein fluorine is contained in the lithium-transition metal composite oxide.

6. The nonaqueous electrolyte secondary battery according to claim 1, wherein the lithium-transition metal composite oxide is represented by the formula: LiₐMnₓNi_{y}Co_{z}O₂,
wherein a, x, y and z satisfy the following: 0≦a≦1.2, x+y+z=1, x>0, y>0, and z≧0.

7. The nonaqueous electrolyte secondary battery according to claim 1, wherein an amount of the nickel in the lithium-transition metal composite oxide and an amount of the manganese in the lithium-transition metal composite oxide are substantially the same.

8. The nonaqueous electrolyte secondary battery according to claim 1, wherein a BET specific surface area of the lithium-transition metal composite oxide is not greater than 3 m²/g.

9. A method of reducing gas generation during storage of a nonaqueous electrolyte secondary battery at a condition of charge in which the nonaqueous electrolyte secondary battery includes, as a material of a positive electrode, a lithium-transition metal composite oxide having a layer structure and containing nickel and manganese as transition metals, the method comprising adding fluorine to the lithium-transition metal composite oxide prior to forming the positive electrode.
